(19) United States
(12) Patent Application Publication
(10) Pub. No.: US 2006/0244779 A1
(43) Pub. Date: Nov. 2, 2006

(54) Pen for use by a printer to print colloidal crystal structures

(76) Inventors: Swaroop K. Kommera, Corvallis, OR (US); Tim R. Koch, Corvallis, OR (US); Herbert T. Etheridge III, Corvallis, OR (US)

Correspondence Address: HEWLETT PACKARD COMPANY, P O BOX 272400, 3404 E. HARMONY ROAD, INTELLECTUAL PROPERTY ADMINISTRATION, FORT COLLINS, CO, 80527-2400, US

(21) Appl. No.: 11/118,193

(22) Filed: Apr. 28, 2005

(51) Int. Cl. B41J 2/165

(52) U.S. Cl. 347/27

(57) ABSTRACT

A pen for use by a printer to print colloidal crystal structures. The pen includes a reservoir that holds a solution, where the solution can be used to grow a colloidal crystal structure. The pen also includes a printhead in fluidic communication with the reservoir and configured to eject drops of the solution.

### BACKGROUND

Colloidal crystallization refers to the phenomenon of colloidal particle self-assembly into a spatially periodic structure. Such a structure may be referred to herein as a “colloidal crystal structure”. These structures may be useful in a number of different applications. For example, a colloidal crystal structure may exhibit a photonic bandgap property and as such may have potential applications in light filters, light emitting devices, lasers, reflectors, wave guides, photonic integrated circuits, digital projectors or front projection screens for example.

Unfortunately, prior art methods of fabricating useful colloidal crystal structures are often impracticable, inflexible, or not cost effective. It is therefore worthwhile to address these limitations.

### BRIEF DESCRIPTION OF THE DRAWINGS

FIG. 1 is a block diagram illustrating one embodiment of a colloidal crystal structure printing system;

FIG. 2 is a flow diagram that illustrates one example of how the printer may operate to print a colloidal crystal structure;

FIG. 3 is plan view of a set of four spatially separated printed colloidal crystal structures;

FIG. 4 is a cross-sectional view of a colloidal crystal structure that may be printed;

FIG. 5 is a diagram of a printer that is in accordance with an embodiment of the invention;

FIG. 6A is a perspective view of a colloidal crystal structure;

FIG. 6B is a flow diagram illustrating one example of how a printer may operate to print a colloidal crystal structure;

FIG. 7 illustrates a colloidal crystal structure printing system;

FIG. 8A is a block diagram of a drop drying system; and

FIG. 8B illustrates the operation of the drop drying system.

### DESCRIPTION

It should be noted that the drawings are not necessarily true to scale. Further, various elements have not been drawn to scale. Certain dimensions have been exaggerated in relation to other dimensions in order to provide a clearer illustration and understanding of embodiments of the present invention. In particular, vertical and horizontal scales may differ and may vary from one drawing to another.

InkJet Printing

By way of introduction we first note that conventional inkjet printing refers generally to a technology that places small drops of ink at selected locations on a print medium. A conventional drop-on-demand inkjet printing system typically includes a printhead, an ink supply which supplies liquid ink to the printhead, and an electronic controller which controls the printhead. The printhead includes one or more print elements each including a nozzle and a mechanism that uses a mechanical, thermal or an electrostatic means to eject ink out through the nozzle and toward a print medium, such as a sheet of paper. Typically, the nozzles are arranged in one or more arrays such that properly sequenced ejection of ink from the nozzles causes characters or other images to be printed upon the print medium.

Colloidal Crystal Structure Printer Construction

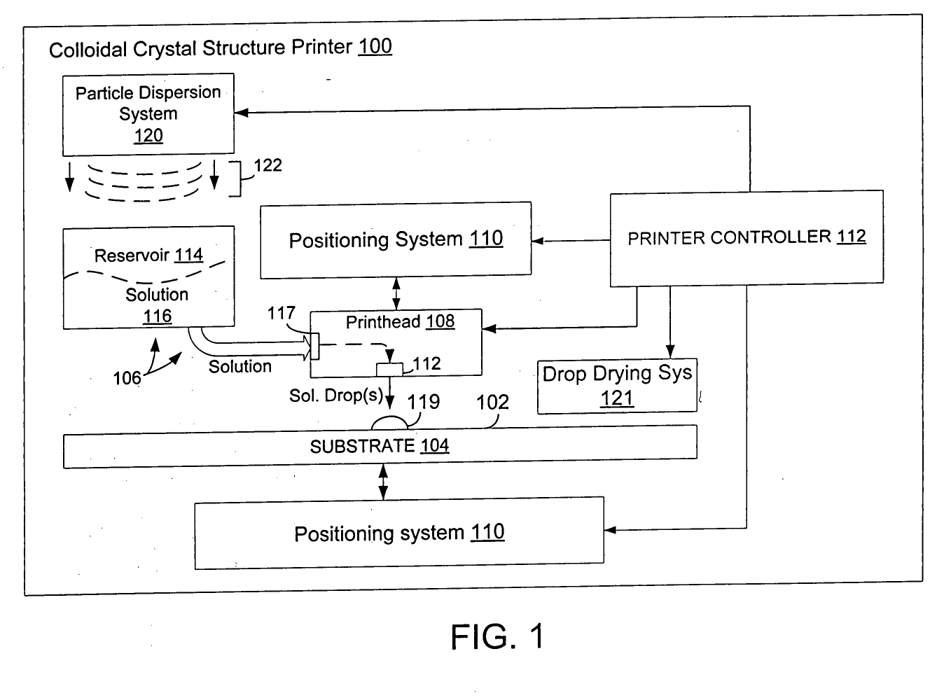

FIG. 1 is a block diagram of a “colloidal crystal structure” printer 100 that is in accordance with one example embodiment of the invention. As is discussed below, the printer 100 is capable of printing colloidal crystal structures on a surface 102 of a substrate 104. The printer 100 in this example includes a solution supply system 106, a printhead 108, a printhead-to-substrate positioning system 110 and a controller 112.

The solution supply system 106 includes a reservoir 114 for holding a supply of a solution 116 and further includes a mechanism for supplying the solution 116 from the reservoir to an inlet 117 of the printhead 108. As such, the solution 116 can flow from the reservoir 114 to the printhead 108. In some implementations, the printhead 108 and the solution supply system 106 are housed together to form a cartridge or pen. In other implementations, the solution supply system 106 is separate from the printhead 108 and supplies the solution 116 through an interface connection, such as a supply tube for example. The reservoir 114 that holds the solution 116 is typically either refillable and/or field replaceable.

The solution 116 may generally be any type of solution that can be used to grow a colloidal crystal on the substrate surface 102 and that can be ejected by the printhead 108 (as is described below). In the present embodiment, for example, the solution 116 includes substantially monodisperse particles mixed in a solvent. In some implementations, the solution particles may be hydrophilic. In other implementations, for example, the particles may be hydrophobic.

For hydrophilic particles the solvent may be water (e.g., De-ionized water) or a type of alcohol (e.g., ethanol, methanol or, propanol), for example, or mixtures thereof. For hydrophibic particles the solvent may be aromatic or aliphatic hydrocarbons or halogenated hydrocarbons (e.g., hexane, toluene, dichloromethane), or mixtures thereof.

Generally, the solution particles may be any suitable shape and size that permits colloidal crystallization. For example, the particles may be of uniform size and of uniform shape, such as oval shaped or sphere shaped. In other implementations, the particles may comprise spheres of different diameters that can self-assemble into a colloidal crystal structure.

In the discussion that follows, however, we will assume that the particles in the solution 116 are substantially uniform diameter spheres. The average diameter of the spheres may be nanometer in scale (e.g., at or below 1000 nanometers), for example. The volume fraction of the spheres in the solution 116 may be selected from a range of 1% to 10%, for example.

The spheres in the solution 116 may generally be formed from any material (or set of materials) that can be used to form a sphere. In various implementations, the spheres may be formed from silica, metal (e.g., Titanium Dioxide) or a polymeric material (e.g., polystyrene), for example. In some implementations, the spheres are homogenous. In other implementations, however, the spheres are not homogenous. For example, the spheres may have a core-shell configuration wherein the cores of the spheres are formed from one material and the shell of the spheres is formed from another material.

In general, the printer 100 can use the printhead 108 and the printhead-to-substrate positioning system 110 to precisely place drops (e.g., drop 119) of the solution 116 at selected locations on the substrate surface 102. The printhead 108 may be a standard inkjet printhead and/or may be designed according to the general principles of a standard inkjet printhead. Accordingly, the printhead 108 includes one or more print elements 112 each including a nozzle and a mechanism that uses a mechanical (e.g., a piezo crystal), electrostatic, or a thermal means (e.g., a thin film resistor) to eject solution 116 out through the nozzle. The positioning system 110 can move the printhead 108 and/or the substrate 104 so as to controllably position the printhead 108 over the substrate surface 102.

It is worthwhile to also note that, in the present embodiment, the printer 100 further includes a particle dispersion system 120 and a drop drying system 121. The dispersion system 120 generally enables the printer 100 to maintain and/or increase the uniformity of particle dispersion in the solution 116. In the present embodiment, for example, the dispersion system 120 provides this function by producing ultrasonic waves 122 that tend to vibrate the solution 116 in the reservoir. As the solution 116 vibrates, the uniformity of particle dispersion in the solution can be maintained or increased.

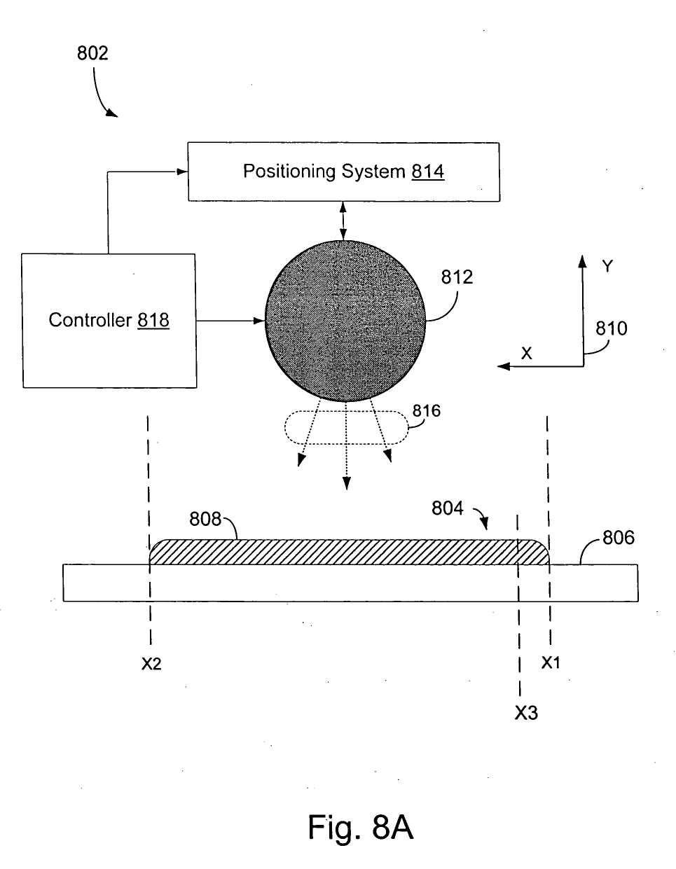

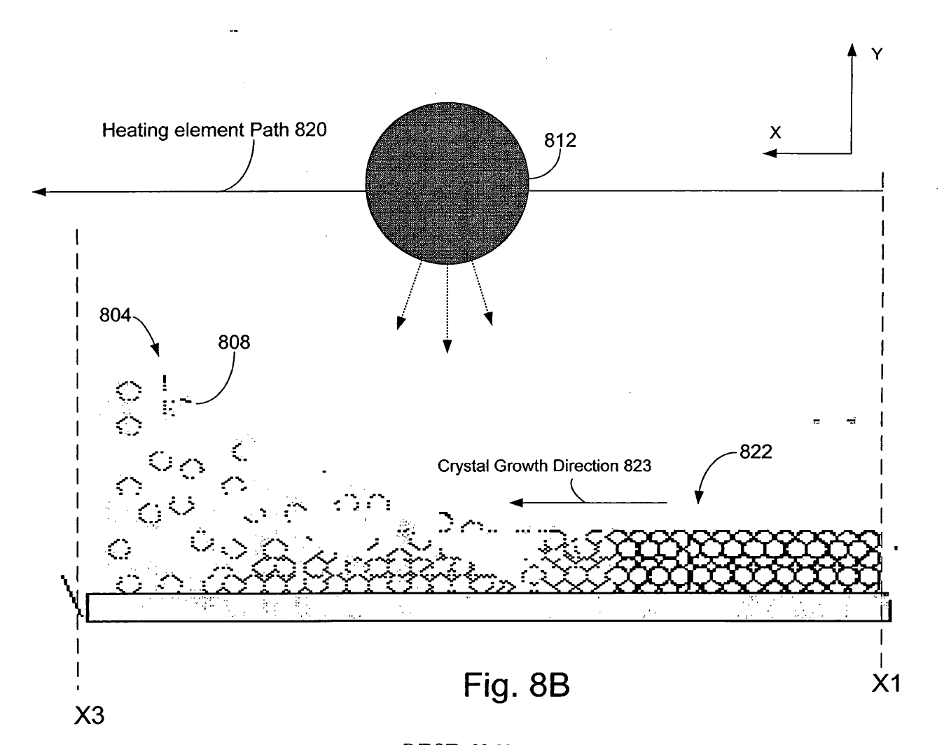

The drop drying system 121 generally enables the printer 100 to apply a pre-determined drying method to the solution drops that are placed on the substrate surface 102. According to one implementation, for example, the drop drying system 121 includes a temperature control system that can raise (or lower) the temperature of drops placed on the substrate surface 102 so as to increase (or decrease) drop evaporation rate. The drop drying system 121 may also include, for example, a mechanism for controlling the air humidity, air pressure and/or (drop local) convective currents. One specific example of a drop drying system is described below with reference to FIGS. 8A and 8B.

The controller 112 generally directs and manages the operation of the printer 100 to print colloidal crystal structures as is described further below. The controller 112 may include one or more processors, firmware, and other printer electronics for communicating with and controlling the various mechanisms in the printer (such as the mechanisms described above). The controller 112 may further include one or more I/O ports that enable the printer 100 to communicate with an external computer, such as an external host computer.

Colloidal Crystal Structure Printer Operation

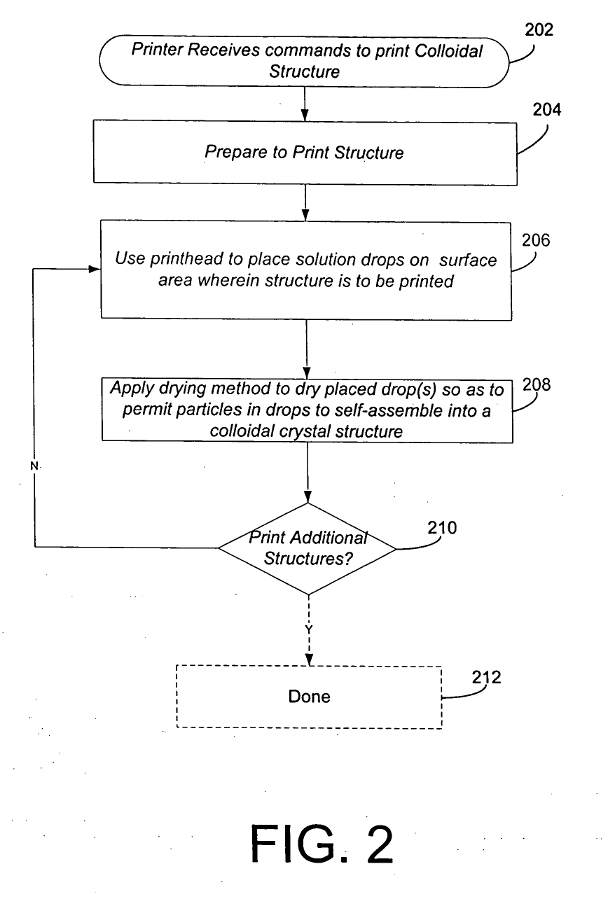

FIG. 2 is a flow diagram that illustrates one example of how the printer 100 may operate (under the direction of the controller 112) to “print” a colloidal crystal structure on a particular area (target area) of the substrate surface 102.

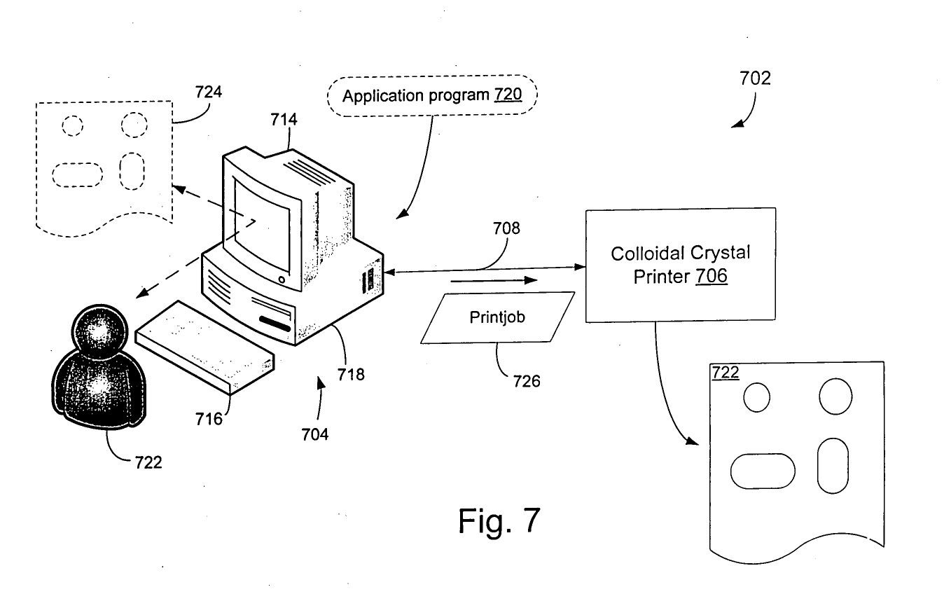

Referring now to FIG. 2, we assume that the printer 100 receives a set of commands that direct the printer 100 to print the colloidal crystal structure (step 202). The set of commands may be in the form of a print job, for example, and may be received by the printer 100 from an external host computer (see FIG. 7, for example). In response to these commands, the printer 100 proceeds to print the colloidal crystal structure as is described below.

At step 204, the printer 100 may perform a “warm-up” process in order to prepare the printer 100 to print the colloidal crystal structure. In the present embodiment, for example, step 204 may involve controlling the dispersion system 120 to apply ultrasonic waves to the solution 116 in order to increase the uniformity of particle dispersion in the solution. This may, for example, improve the quality of the colloidal crystal structure that is about to be printed.

At step 206, the printer 100 uses the printhead 108/positioning system 110 to precisely place drops of the solution 116 on the target area of the substrate surface 102 wherein the colloidal crystal structure is to be printed. The printer 100 may perform this step so as to completely cover the target area with drops of the solution 116.

At step 208, the printer 100 applies a predetermined drying method (using the drop drying system 121) in order to cause the solvent in the placed drops to evaporate in a controlled manner. As the solvent in the drops evaporates, the particles in the drops tend to settle and self-assemble so as to form an “N” layer colloidal crystal structure on the target area. It is noted that the value of “N” may be a function of the volume fraction of the spheres in the solution 116 as well as the drying method used to dry the drops. Accordingly, the value of the “N” may be varied, for example, by varying the solution volume fraction and/or the drying method applied at step 208.

At step 210, the printer 100 may proceed to print additional colloidal crystal structures at other locations on the substrate surface 102 in a similar manner. At step 212, the printing process ends and additional processes may then be applied to the printed colloidal crystal structures.

As is known in the art, a number of different factors may influence the properties of a colloidal crystal that is grown from a solution. Many of these factors have been studied in the prior art literature and include: the material (or materials) used to form the solution particles; the size and shape of the particles; the dielectric constant of the particles; the refractive index of the particles; the particle volume fraction; the ionic strength of the solution; the properties of the substrate surface on which the colloidal crystal is formed, etc.

It is noted that these factors may individually (or in combination) be tailored to control the properties of a colloidal crystal structure that is printed by the printer 100. Accordingly, the printer 100 (e.g., by adjusting one or more of the factors that influence colloidal crystal growth) may be configured to print any number of different types of colloidal crystal structures and these structures can have a wide variety of different properties and uses.

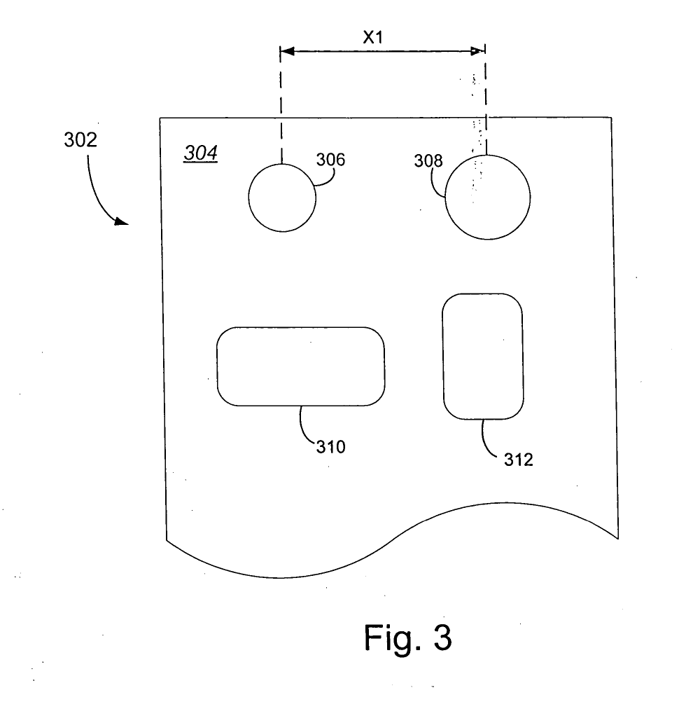

It is further noted that the ability of the printer 100 to precisely place drops of the solution 116 on a substrate surface allows for the printing of a wide variety of differently shaped and differently oriented colloidal crystal structures. To illustrate one specific example of this ability, attention is directed to FIG. 3.

FIG. 3 is a plan view of a set of four spatially separated colloidal crystal structures 302 that may printed on a substrate surface 304 by the printer 100. The four colloidal crystal structures in this example include a first and a second colloidal crystal structure 306, 308 that are each circular in shape and that are separated by a center-to-center distance of “X1”. In this example, the diameter of the first colloidal crystal structure 306 is less than the diameter of the second colloidal crystal structure 308. The third and fourth colloidal crystal structures 310, 312 are each generally rectangular in shape but are differently oriented on the substrate surface 304.

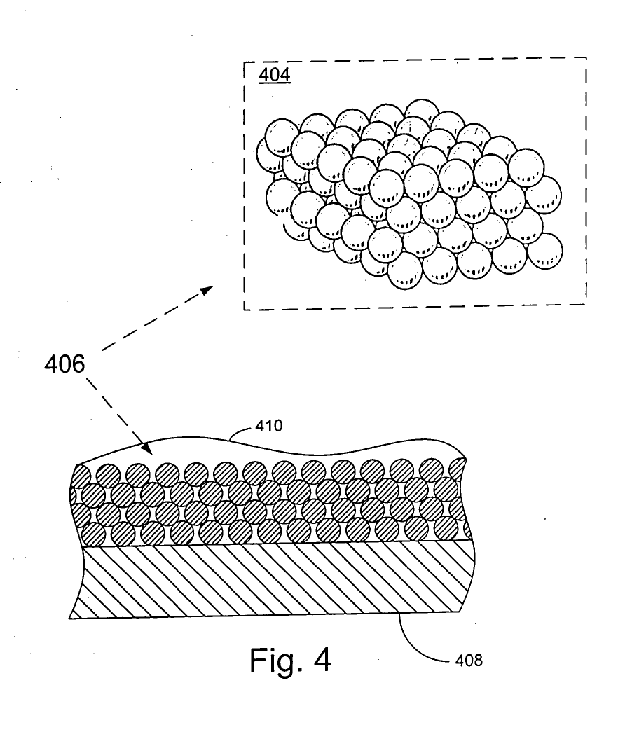

It is noted that a printer embodying the invention may be capable of printing colloidal crystal structures that have certain desired optical properties, such as a desired photonic bandgap property for example. By way of one specific example, attention is directed to FIG. 4.

FIG. 4 shows a cross-sectional view as well as a perspective view (shown within box 404) of a colloidal crystal structure 406 that may be printed by the printer 100 on a substrate 408 according to one specific implementation. In this example, we will assume the substrate 408 is formed from a glass material.

As shown the printed colloidal crystal structure 406 comprises 4 layers (i.e., N=4 in this example) of nanometer scale spheres arranged in a close-packed geometry. The symmetry of the structure 406 may correspond to a face centered crystalline structure (FCC), a hexagonal close packed structure (HCP), or some other randomly stacked polycrystalline structure.

In this example, the printed colloidal crystal structure 406 may have a photonic bandgap property. As such, the printed colloidal crystal structure 406 may be used as a filter for filtering electromagnetic radiation having frequencies that fall within the bandgap and/or to reflect frequencies corresponding to the bandgap frequencies.

It is also noted that in this example, the colloidal crystal structure 406 may be coated with a coating 410 after being printed. The coating 410 may be a polymer in some implementations that serves to stabilize the printed colloidal crystal structure 404. In some applications, such as applications wherein the structure 404 is to be used as a light filter, the coating may be transparent to light.

It is noted that in the embodiment just described we discussed the possibility that the colloidal crystal structure 406 includes a photonic bandgap property. As a person skilled in the art will recognize, additional sphere layers in the structure may in fact be needed (depending on sphere dielectric constant, for example) in some cases for a photonic bandgap property to exist.

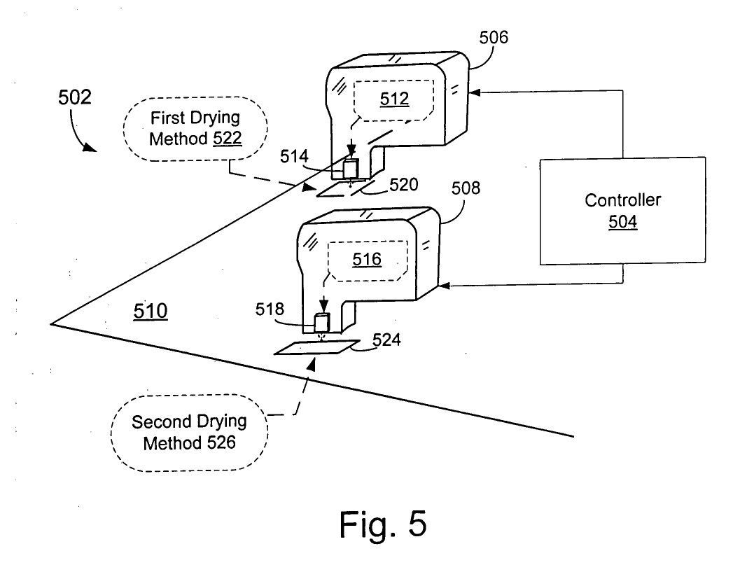

It is noted that a printer embodying the invention may include (or have access to) different types of solutions and may be able to use these different solution types to print different types of colloidal crystals structures on, for example, the same substrate. The printer discussed below in connection with FIG. 5 illustrates one embodiment of such a printer.

FIG. 5 is somewhat of an abstract diagram that shows components of a printer 502 that is in accordance with an embodiment of the invention. As shown, the printer 502 includes a controller 504, a first pen 506 and a second pen 508. The printer 502 may also include other pens (that are not shown). Additionally, the printer 502 may include a carriage mechanism for selectively moving each of the pens with respect to a substrate surface 510 in accordance with control instructions issued from the controller 504.

Both the first pen 506 and the second pen 508 include a respective reservoir for holding a supply of solution that can be used to grow a colloidal crystal. The pens 506, 508 further include respective printheads 514, 518 configured to eject drops of the solution pursuant to control instructions issued from the controller 504.

For illustration purposes we will assume that the first pen 506 holds a first type of solution (solution 512) that enables the first pen 506 to be used to print a first type (crystal type “A”) of colloidal crystal structure. We will also assume that the second pen holds a second type of solution (solution 516) that enables the second pen 508 to be used to print a second type (crystal type “B”) of colloidal crystal structure.

FIG. 5, for example, illustrates the printer 502 presently using the first pen 506 to print a type “A” colloidal crystal structure on an area 520 of the substrate surface 510. As indicated in FIG. 5, this printing operation involves the use of the first pen 506 to place (via printhead drop ejection) drops of the solution 512 on the area 520 of the substrate surface 510. The printer 502 then applies a first drying method 522 to these drops in order to cause (or permit) the drops to evaporate. As the drops dry, colloidal crystallization occurs resulting in the type “A” colloidal crystal structure being formed over the substrate surface area 520.

FIG. 5 also illustrates the printer 502 presently using the second pen 508 to print a type “B” colloidal crystal structure on an area 524 of the substrate surface 510. As indicated in FIG. 5, this operation is performed by the second pen 508 placing drops of the solution 516 on the surface area 524. The printer may then apply a second drying method 526 to these drops so as to cause the drops to dry. As the drops dry, colloidal crystallization occurs resulting in the “type B” colloidal crystal structure being formed.

It is noted that in some implementations, the first drop drying method 522 and the second drop method 526 may be different drying methods and may be tailored to account for the differences between the two solutions 512, 516. For example, the first drying method 522 may involve raising drop temperature to a pre-determined temperature that is above room temperature and/or may involve creating a temperature gradient within the drop solution. The second drying method 526 may involve allowing the drop solution to evaporate at room temperature, for example.

It is further noted that in some implementations, the printer 502 may be capable of using more than one pen to print a single colloidal crystal structure. This capability can add further to the types of crystal structures the printer 502 can print. To illustrate this feature, we will assume in the next part of this discussion that the first pen solution 512 and the second pen solution 516 each are monodisperse (or substantially monodisperse) colloids that include substantially uniform diameter spheres (of nanoscale size) mixed in a solvent. The average diameter (“D1”) of the spheres in the first pen solution 512 is larger, however, than the diameter (“D2”) of the spheres in the second pen solution 516.

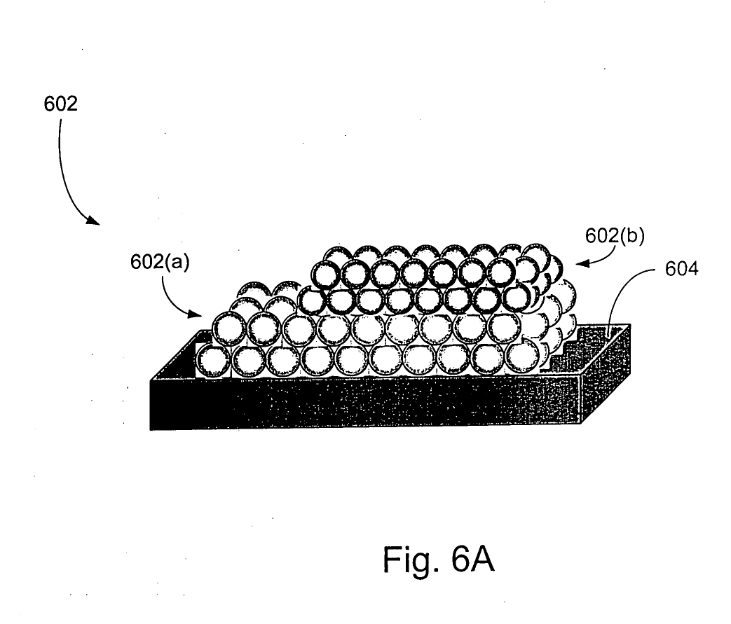

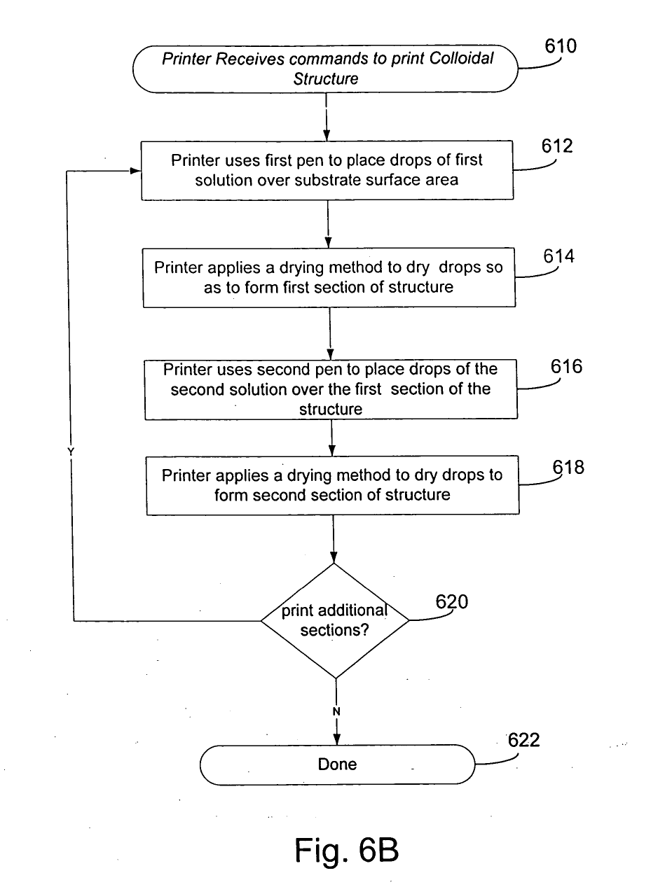

FIG. 6A shows a colloidal crystal structure 602 that may be printed by the printer 502 on a target area 604 using the two pens 506, 508 in this example. As shown, the colloidal crystal structure 602 includes a first section 602(a) and a second section 602(b). The first section 602(a) is printed using the first pen 506 and is therefore formed from the larger “D1” diameter spheres of the first pen solution 512. The second section 602(b) of the colloidal crystal structure 602 is printed using the second pen 508 and is therefore formed from the smaller “D2” diameter spheres of the second pen solution 516.

FIG. 6B is a flow diagram illustrating one example of how the printer 502 may operate to print the colloidal crystal structure 602. As shown in FIG. 6B, we assume that the printer 502 receives electronic commands to print the colloidal crystal structure 602 at a particular area (target area 604) on the substrate surface 510 (step 610). In response to these commands, the printer 502 proceeds to print the colloidal crystal structure 602 as is described below.

At step 612, the printer 502 uses the first pen 506 to place drops of the solution 512 over the target area 604. At step 614, the printer 502 applies a pre-determined drying method (e.g., the first drying method 522) to the drops placed on the target area 604 at step 612. As the drops dry the “D1” diameter spheres in the drops self-assemble to form, over the target area 604, the first section 602(a) of the colloidal crystal structure 602.

At step 616, the printer 502 uses the second pen 508 to place drops of the second pen colloidal crystal solution 516 over the first section 602(a). At step 618, the printer 502 applies a pre-determined drying method (e.g., the second drying method 526) to the drops placed at step 616. As the drops dry, the “D2” diameter spheres in the drops self-assemble to form (over the first colloidal crystal section 602(a)) the second section 602(b) of the colloidal crystal structure 602.

In some implementations, the printer may proceed to build additional sections (not shown in FIG. 6A) in the colloidal crystal structure 602 in a similar manner (step 620). At step 622, the printing process ends.

FIG. 7 illustrates a colloidal crystal structure printing system 702 that is in accordance with an embodiment of the invention. As shown, the printing system 702 includes a host computer 704 connected to a colloidal crystal structure printer 706 via a communication link 708. The communication link 708 may represent any type of data path, such as network or a communication cable for example.

The printer 706 may be capable of printing any number of different types of colloidal crystal structures in accordance with the principles previously described in this document. The host computer 704 may include a display monitor 714, a user input device 716 and a central processing system 718. As indicated in FIG. 7, the host computer 704 executes an application program 720 which the computer 704 may store in a local memory.

The application program 720 displays a graphical user interface (GUI) in this example. The GUI may include computer aided design facilities that allow a user to define/draw the physical layout of a pattern (e.g., pattern 724) of one or more colloidal crystal structures that the user wishes to print on a substrate surface (e.g. substrate surface 722) using the printer 706.

After the user 722 has defined the desired pattern, he/she can further interact with the GUI to cause the computer 704 to generate and transmit a print job (e.g. print job 726) that directs the printer 706 to print the (user defined) pattern. Thus, for example, the print job 726 may direct the printer 706 to print the user defined colloidal crystal structure pattern 724 onto a substrate surface 722. The printer 706 is responsive to the print job 726 by printing the pattern 724 on the substrate surface 722.

It is worthwhile to note that in some embodiments, a substrate that will be used for printing colloidal crystal structures may be modified (prior to the printing process) to prevent or limit undesired solution mobility on the surface of the substrate. Such modification may be in the form of surface structural features (e.g., such as wells for collecting solution drops) and/or surface chemical treatments, for example.

By way of one specific example, consider once again the printed structures shown in FIG. 3. Prior to the printer 100 printing these structures, the substrate surface 304 may be selectively treated with a hydrophobic and/or a hydrophilic substance. According to one implementation, for example, the surface 304 is treated with a hydrophilic substance in areas that correspond to those areas (target areas) wherein the colloidal crystal structures (306, 308, 310 and 312) are to be printed. Areas surrounding the target areas may be treated with a hydrophobic substance, for example. During the printing of the colloidal crystal structures, such an arrangement may prevent or limit undesired drop solution mobility off the target areas into areas surrounding the target areas.

FIG. 8A is a block diagram of a drop drying system 802 that is accordance with one embodiment of the invention. The drop drying system 802 may be incorporated within a colloidal crystal structure printer and can be used by such a printer, for example, to dry a quantity of solution drops 804 placed on a substrate surface 806 via a printhead and/or a pen.

Shown in FIG. 8A is a cross-sectional view of the solution 804 and the air/solution boundary 808 just prior to a drying procedure (described below) being performed. We assume in this example an XY coordinate system 810 and that the air/solution boundary 808, in an XY plane, spans from an “X1” coordinate to an “X2” coordinate as shown.

In this embodiment, the drop drying system 802 includes a heating element 812 that can be moved (by a positioning system 814) relative to the solution 804. As indicated in FIG. 8A, the heating element 812 can emit electromagnetic radiation 816 that can be absorbed by the solution 804 and thereby raise solution temperature. The electromagnetic radiation 816 emitted by the heating element 812 may be infrared or microwave radiation, for example.

In this embodiment, both the heating element 812 and the positioning system 814 operate under the control of a controller 818. The controller 818 may be the main controller of the printer that incorporates the drop drying system 802, for example. In some cases, the positioning system 814 may have a dual use in that it is also used to move the printhead/pen that was originally used by the printer to place the solution 804 on the substrate surface 806.

FIG. 8B is an exploded cross-sectional view of the solution 804 between coordinates X1 and X3 during a drying operation. As indicated in FIG. 8B, during a drying operation, the heating element 812 produces electromagnetic radiation 816 and is also moved at a controlled rate over the air/solution boundary 808 along a path 820 that may originate at or near the X1 coordinate.

As the heating element 812 travels along the path 820, the electromagnetic radiation 816 emitted by the heating element 812 causes the solution temperature to rise thereby increasing solution evaporation rate. Typically solution temperature (and therefore evaporation rate) is higher at locations that are proximate to the heating element 812. This may result in colloidal crystal growth along the direction shown (crystal growth direction 823) which is parallel to the heating element 812 travel direction.

It is further noted that the present invention may be embodied in the form of a “computer-readable medium”. As used herein, the phrase “computer readable medium” can refer to any medium that can contain, store or propagate computer executable instructions. Thus, in this document, the phrase “computer-readable medium” may refer to a medium such as an optical storage device (e.g., a CD ROM) or a magnetic storage device (e.g., a magnetic tape). The phrase “computer-readable medium” may also refer to signals that are used to propagate the computer executable instructions over a network or a network system, such as the Public Internet.

Thus, a memory component that stores computer executable instructions may represent an embodiment of the invention. Furthermore, signals used to propagate the software or firmware over a communication link (e.g. an intranet, Public Internet, etc) may also represent an embodiment of the invention.

Although several specific embodiments of the invention have been described and illustrated, the invention is not to be limited to specific forms or arrangements of parts so described and illustrated. The invention is limited only by the claims and the equivalents thereof.

What is claimed is:

1. A pen for use by a printer to print colloidal crystal structures, the pen comprising:
(a) a reservoir that holds a solution, where the solution can be used to grow a colloidal crystal structure; and
(b) a printhead in fluidic communication with the reservoir and configured to eject drops of the solution.

2. The pen of claim 1, wherein the solution includes substantially monodisperse particles mixed in a solvent.

3. The pen of claim 1, wherein the solution includes oval shaped particles mixed in a solvent.

4. The pen of claim 1, wherein the solution includes spheres of various diameters mixed in a solvent.

5. The pen of claim 1, wherein the solution includes spheres of generally the same diameter mixed in a solvent.

6. The pen of claim 1, wherein the solution includes hydrophilic particles mixed in a solvent.

7. The pen of claim 1, wherein the solution includes hydrophilic particles mixed in a solvent;
wherein the hydrophilic particles are capable of self-assembling into a colloidal crystal;
wherein the solvent is selected from: water, ethanol, methanol and propanol.

8. The pen of claim 1, wherein the solution includes hydrophobic particles mixed in a solvent.

9. The pen of claim 1,
wherein the solution includes hydrophobic particles mixed in a solvent;
wherein the hydrophobic particles are capable of self-assembling into a colloidal crystal;
wherein the solvent is selected from the group consisting of:
an aromatic hydrocarbon, an aliphatic hydrocarbon and a halogenated hydrocarbon.

10. The pen of claim 1,
where the solution comprises substantially monodisperse spheres mixed in a solvent.

11. The pen of claim 1,
where the solution comprises substantially monodisperse spheres mixed in a solvent;
wherein the average diameter of the monodisperse spheres is below 1001 nm.

12. The pen of claim 1,
wherein the solution comprises substantially monodisperse spheres mixed in a solvent;
wherein the average diameter of the monodisperse spheres is below 1001 nm;
wherein the monodisperse spheres are formed, at least in part, from silica.

13. The pen of claim 1,
wherein the solution comprises substantially monodisperse spheres mixed in a solvent;
wherein the average diameter of the monodisperse spheres is below 1001 nm;
wherein the monodisperse spheres are formed, at least in part, from a metal.

14. The pen of claim 1,
wherein the solution comprises substantially monodisperse spheres mixed in a solvent;
wherein the average diameter of the monodisperse spheres is below 1001 nm;
wherein the monodisperse spheres are formed, at least in part, from Titanium Dioxide.

15. The pen of claim 1, wherein the solution comprises substantially monodisperse spheres mixed in a solvent;
wherein the average diameter of the monodisperse spheres is below 1001 nm;
wherein the monodisperse spheres are formed, at least in part, from polystyrene.

16. The pen of claim 1,
wherein the solution comprises spheres of generally uniform diameter and composition mixed in a solvent;
wherein the volume fraction of the spheres in the solvent is within a range of 1% to 10%.

17. The pen of claim 1, wherein the solution can be used to grow a colloidal crystal having a photonic bandgap property.

18. A solution supply system for use within a printer capable of printing colloidal crystal structures, the supply system comprising:
a reservoir holding a supply of solution that can grow a colloidal crystal structure; and
means for delivering the solution from the reservoir to an inlet of a printhead.

19. The solution supply system of claim 18,
wherein the solution is a mixture of substantially monodisperse spheres mixed in a solvent;
wherein the average diameter of the spheres is below 1001 nm.

20. The solution supply system of claim of claim 18,
wherein the solution comprises spheres mixed in a solvent;
wherein the spheres have substantially the same diameter;
wherein the volume fraction of the spheres in the solvent is above 1%.

21. The solution supply system of claim 18,
wherein the solution comprises spheres mixed in de-ionized water;
wherein the spheres have substantially the same diameter;
wherein the volume fraction of the spheres in the water is within a range of 1% to 10%.

22. The solution supply system of claim 18,
wherein the solution comprises spheres mixed in an alcohol;
wherein the spheres have substantially the same diameter;
wherein the average diameter of the spheres is below 1001 nm; and
wherein the volume fraction of the spheres in the alcohol is within a range of 1% to 10%.

23. A method of configuring a pen, comprising:
providing a pen installable within a printer, the pen includes a reservoir and a printhead;
providing a solution that can be used to grow a colloidal crystal structure; and
placing the solution in the pen reservoir.

24. The method of claim 23, wherein the solution can be used to grow a colloidal crystal structure having a photonic bandgap property.

25. The method of claim 24, wherein the solution providing step includes:
preparing the solution by mixing spheres of generally uniform diameter with a solvent.

26. The method of claim 24, wherein the solution providing step includes:
preparing the solution by mixing particles of generally uniform size with a solvent.

27. The method of claim 24, wherein the solution is a monodisperse colloid.
